(19) United States
(12) Patent Application Publication
(10) Pub. No.: US 2026/0221709 A1
(43) Pub. Date: Jul. 30, 2026

(54) MID-INFRARED CHIRPED PULSE AMPLIFIER

(71) Applicant: University of Central Florida Research Foundation, Inc., Orlando, FL (US)

(72) Inventors: Zachary Alphonse Marra, Oviedo, FL (US); Chang Zenghu, Oviedo, FL (US); Fangjie Zhou, Orlando, FL (US); Yi Wu, Oviedo, FL (US)

(73) Assignee: University of Central Florida Research Foundation, Inc., Orlando, FL (US)

(21) Appl. No.: 18/646,498

(22) Filed: Apr. 25, 2024

Related U.S. Application Data
(60) Provisional application No. 63/462,375, filed on Apr. 27, 2023.

(51) Int. Cl. H01S 3/00; G02F 1/355; H01S 3/04; H01S 3/094; H01S 3/10; H01S 3/16; H01S 3/23

(52) U.S. Cl. CPC H01S 3/0057; G02F 1/3558; H01S 3/0405; H01S 3/094076; H01S 3/10092; H01S 3/1643; H01S 3/2325

(57) ABSTRACT

In accordance with at least one aspect of this disclosure, an optical system for amplifying the power of a MIR laser using chirped pulse amplification. In certain embodiments, the optical system can include a MIR seed generator system configured to output an optical seed signal. In certain embodiments, the optical system can include a stretcher in optical communication with the seed generator system to receive the optical seed signal. In certain embodiments, the optical system can include an amplifier assembly in optical communication with the stretcher to receive the stretched seed signal. The amplifier assembly can be configured to comprise of a cryogenically cooled gain medium configured to receive the stretched seed signal and amplify the stretched seed signal to output an amplified optical signal.

### CROSS-REFERENCE TO RELATED APPLICATIONS

This application claims priority to and the benefit of U.S. Provisional Application No. 63/462,375, filed Apr. 27, 2023, the entire contents of which are herein incorporated by reference in their entirety.

### STATEMENT OF GOVERNMENT RIGHTS

This invention was made with government support under contract no. FA9550-20-1-0295 awarded by the Air Force Office of Scientific Research. This invention was made with government support under contract no. 2207674 awarded by the National Science Foundation. This invention was made with government support under contract no. HDTRA11910026 awarded by the Defense Threat Reduction Agency 3512. The government has certain rights in the invention.

### FIELD

This disclosure relates to systems and methods for mid-infrared chirped pulse amplification.

### BACKGROUND

Chirped pulse amplifiers (CPAs) are used in several applications. Traditional CPA systems stretch an initial signal, amplify the stretched signal and then compress the signal for output at near infrared wavelengths. Such conventional methods and systems have generally been considered satisfactory for their intended purpose. However, there is still a need in the art for extending the technique to mid-infrared (MIR). This disclosure provides a solution for this need.

### SUMMARY

In accordance with at least one aspect of this disclosure, an optical system for amplifying the power of a laser using chirped pulse amplification can include a MIR seed generator system configured to output an optical seed signal. In certain embodiments, the optical system can include a stretcher in optical communication with the seed generator system to receive the optical seed signal. The stretcher can be configured to stretch the optical seed signal to output a stretched seed signal. In certain embodiments, the optical system can include an amplifier assembly in optical communication with the stretcher to receive the stretched seed signal. The amplifier assembly can include a cryogenically cooled gain medium configured to receive the stretched seed signal and amplify the stretched seed signal to output an amplified optical signal. The amplifier assembly can also include one or more gain pumps which can be configured to output one or more pump signals to pump the cryogenically cooled gain medium. In certain embodiments, the optical system can include a compressor in optical communication with the amplifier assembly configured to receive the amplified optical signal and configured to compress the amplified optical signal to output an output optical signal.

In certain embodiments, the MIR seed generator system can include a Yb:KGW optical source configured to output an initial optical seed signal. The initial optical seed signal can be one or more of (e.g., all of) about 247 femtoseconds, about 100 microjoules, and/or about 1.025 micrometers. In certain embodiments, the seed generator system can include one or more one or more mid-infrared generator elements configured to generate one or more infrared signals from infrared generator optical input signal. In certain embodiments, the one or more mid-infrared generator elements can be one or more periodically poled lithium niobate (PPLN) crystals. The one or more PPLN crystals can be disposed optically between a combiner grating and an output grating. In certain embodiments, the one or more PPLN crystals can be configured to receive the infrared generator optical input signal from the combiner grating to output a PPLN output signal to the output grating. The output grating can be configured to separate the one or more infrared signals from the PPLN output signal to output the optical seed signal. In certain embodiments, the focal point of the combiner grating can be at the output grating. In certain embodiments, the MIR seed signal can be below about 4.2 micrometers and/or about 4.07 micrometers. The optical MIR signal can also about 150 femtoseconds and/or about 2.7 microjoules. In certain embodiments, the stretcher can be an Öffner stretcher.

In certain embodiments, the MIR amplifier assembly can include an eight-pass bowtie amplifier arrangement. A faraday isolator can be disposed between the stretcher and the amplifier assembly, wherein the faraday isolator is configured to prevent signals from returning backward to and/or through the stretcher. In certain embodiments, the amplifier assembly can also include a cryogenically cooled gain medium. In certain embodiments, the cryogenically cooled gain medium can be or include Fe:ZnSe. The cryogenically cooled gain medium can comprise one or more gain crystals. In certain embodiments, the one or more gain crystals can be cut at a Brewster's angle (e.g., 67.5 degrees). In certain embodiments, the one or more gain crystals can be or include two single-crystal Fe:ZnSe crystals. In certain embodiments, at least one surface of the cryogenically cooled gain medium can be coated with graphite. In certain embodiments, the cryogenically cooled gain medium can be disposed in a vacuum chamber. In certain embodiments, only the cryogenically cooled gain medium is disposed in the vacuum chamber. In certain embodiments, the amplifier assembly can be disposed in the vacuum chamber. In certain embodiments, only the amplifier assembly is disposed in the vacuum chamber.

In certain embodiments, the one or more gain pumps can be or include Er:YAG configured to output a pump laser signal. In certain embodiments, the one or more gain pumps can be or include two gain pumps disposed on opposite sides of the gain crystal. In certain embodiments, the pump laser signal can be configured to be about 34 millijoules, about 100 microseconds, about 333 hertz, and/or about 2.94 micrometers. In certain embodiments, the amplifier assembly can be configured to vertically polarize the one or more pump beams. In certain embodiments, the output MIR signal can be below about 4.2 micrometers and/or about 4.07 micrometers. The output MIR signal can be about 333 hertz, about 250 femtoseconds, and/or about 4.59 millijoules.

In accordance with at least one aspect of this disclosure, a method for amplifying the power of a MIR laser using chirped pulse amplification can include generating an output signal below about 4.2 micrometers and at or above about 300 hertz. In certain embodiments, the generation can be performed in about room temperature open air. In certain embodiments, the method can include using a cryogenically cooled chirped pulse amplifier. The cryogenically cooled chirped pulse amplifier can comprise a cryogenically cooled gain medium. In certain embodiments, the method can include cooling the cryogenically cooled chirped pulse amplifier and/or the cryogenically cooled gain medium. The method can include cooling the cryogenically cooled gain medium to about 40 kelvins. In certain embodiments, the method can also include exposing to vacuum (e.g., or suitable lower pressure) only the cryogenically cooled chirped pulse amplifier and/or the cryogenically cooled gain medium (e.g., cryogenically cooling the chirped pulse amplifier and/or gain medium in a vacuum chamber). In certain embodiments, the method can further include using one or more periodically poled lithium niobate crystals to generate mid-infrared signals from an initial optical seed signal.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an embodiment of a MIR chirped pulse amplifier system in accordance with this disclosure;

FIG. 2 is a graph showing amplified spontaneous emission (ASE) and amplifier output voltage measurements over time of one or more embodiments of this disclosure (e.g., of FIG. 1);

FIG. 3A is a graph showing long-term power fluctuation of one or more embodiments of this disclosure (e.g., of FIG. 1);

FIG. 3B is a graph showing measured pulse energy and predicted pulse energy versus pass number of one or more embodiments of this disclosure (e.g., of FIG. 1);

FIG. 4 is a graph showing amplifier output energy and pump pulse energy versus repetition rates of one or more embodiments of this disclosure (e.g., of FIG. 1);

FIG. 5 is a graph showing spectra before and after amplification, and showing five (5) meters of atmospheric transmission of one or more embodiments of this disclosure (e.g., of FIG. 1);

FIG. 6A is a graph showing pulse shape and phase retrieved of one or more embodiments of this disclosure (e.g., of FIG. 1);

FIG. 6B is a graph showing a comparison of measured intensity autocorrelation traces and reconstructed intensity autocorrelation traces based on a measured pulse shape for the embodiment of FIG. 6A;

FIG. 7A is a graph showing beam profile and beam quality after compression of one or more embodiments of this disclosure (e.g., of FIG. 1);

FIG. 7B is an image showing beam profile and beam quality after compression of for the embodiment of FIG. 7A;

FIG. 8A is a graph showing a harmonics spectrum of one or more embodiments of this disclosure (e.g., of FIG. 1) spanning the sensitivity regions of a Si-based and an InGaAs-based spectrometer; and

FIG. 8B is an image showing conical emission from the filament for the embodiment of FIG. 8A.

### DETAILED DESCRIPTION

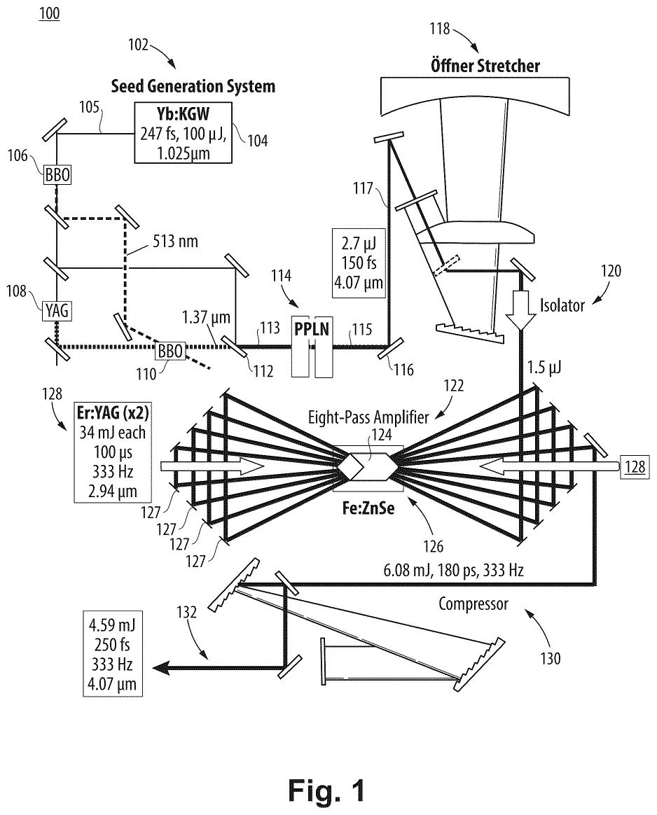

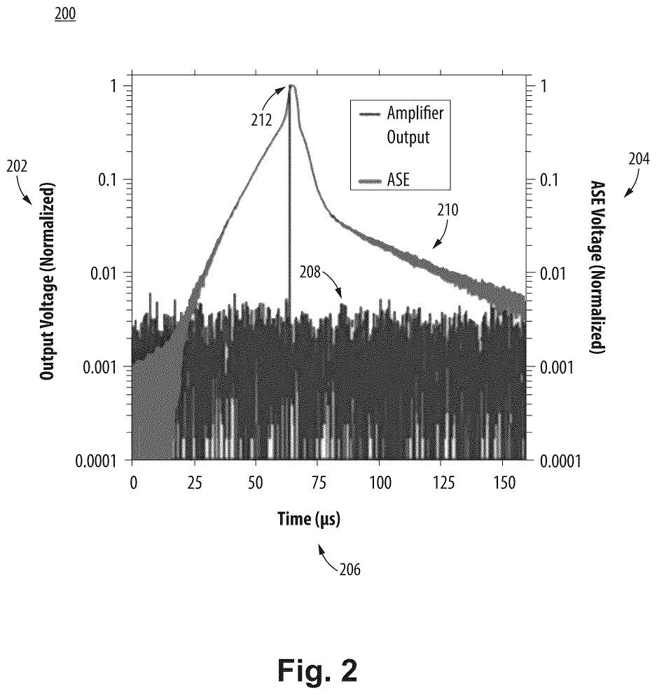

Reference will now be made to the drawings wherein like reference numerals identify similar structural features or aspects of the subject disclosure. For purposes of explanation and illustration, and not limitation, an illustrative view of an embodiment of a MIR chirped pulse amplification system in accordance with the disclosure is shown in FIG. 1 and is designated generally by reference character 100. Other views, embodiments, and/or aspects of this disclosure are illustrated in FIGS. 2-8. Certain embodiments disclosed herein can be used to amplify the power of a MIR laser using chirped pulse amplification, for example.

In accordance with at least one aspect of this disclosure, an optical system 100 for amplifying the power of a MIR laser using chirped pulse amplification the optical system 100 can include a MIR seed generator system 102 configured to output an optical seed signal 117. In certain embodiments, the optical system 100 can include a stretcher 118 in optical communication with the seed generator system 102 to receive the optical seed signal 117. The stretcher 118 can be configured to stretch the optical seed signal 117 to output a stretched seed signal.

In certain embodiments, the optical system can include an amplifier assembly 122 in optical communication with the stretcher 118 to receive the stretched seed signal. The amplifier assembly 122 can include a cryogenically cooled gain medium 124 configured to receive the stretched seed signal and amplify the stretched seed signal to output an amplified optical signal. The amplifier assembly 122 can also include one or more gain pumps 128 which can be configured to output one or more pump signals to pump the cryogenically cooled gain medium 124. In certain embodiments, the optical system 100 can include a compressor 130 in optical communication with the amplifier assembly 122 configured to receive the amplified optical signal and configured to compress the amplified optical signal to output an output optical signal 132.

In certain embodiments, the seed generator system 102 can include an optical source 104 (e.g., Ytterbium-doped Potassium-Gadolinium Tungstate (Yb:KGW)) configured to output an initial optical seed signal 105. Any other suitable optical source configured to provide a desired initial signal is contemplated herein. The initial optical seed signal 105 can be one or more of (e.g., all of) about 247 femtoseconds, about 100 microjoules, and/or about 1.025 micrometers. Any other suitable characteristics for a desirable result for the initial optical seed signal are contemplated herein.

In certain embodiments, the MIR seed generator system 102 can include one or more infrared generator elements configured to generate one or more infrared signals from infrared generator optical input signal 113. In certain embodiments, the one or more infrared generator elements can be one or more PPLN crystals 114, e.g., as shown. In certain embodiments, the seed generator system 102 can include a Lanthanum Gallium Silicate (LGS) crystal configured to generate one or more infrared signals from an LGS optical input signal. The one or more infrared signals can be mid-infrared (MIR) light. In certain embodiments, the initial optical seed signal 105 can have suitably high intensity for attaining a desired effect for the generation of infrared light due to its intensity dependency.

The one or more PPLN crystals 114 can be disposed optically between a combiner grating 112 and an output grating 116. In certain embodiments, the one or more PPLN crystals 114 can be configured to receive the infrared generator optical input signal 113 from the combiner grating 112 to output a PPLN output signal 115 to the output grating 116. In certain embodiments the output grating 116 can be a diffraction grating (e.g., a long pass wavelength filter). The output grating 116 can be configured to separate the one or more infrared signals from the PPLN output signal 115 to output the optical seed signal 117. In certain embodiments the output grating 116 can be configured to act as a mirror to the longer wavelength light but diffract shorter wavelength light.

In certain embodiments, the focal point of the combiner grating 112 can be at the output grating 116. In certain embodiments, the optical seed signal 117 can be below 4.2 micrometers and/or about 4.07 micrometers. The optical seed signal 117 can also be about 150 femtoseconds and/or about 2.7 microjoules. In certain embodiments, the output grating is configured to output an about 4.07 μm wavelength optical seed signal.

In certain embodiments, the stretcher 118 can be an Öffner stretcher. Any other suitable stretcher that achieves a desired result is contemplated herein.

In certain embodiments, the optical system 100 can include an isolator 120 (e.g., a faraday isolator made by Thorlabs). The isolator 120 can be disposed between the stretcher 118 and the amplifier assembly 122 and can prevent signals from returning backward to and/or through the stretcher 118.

In certain embodiments, the amplifier assembly 122 can include an eight-pass bowtie amplifier arrangement, e.g., as shown constructed of a plurality of mirrors 127 or other suitable optical elements. Any other suitable number of passes (e.g., more or less) that produce a desired result, are contemplated herein.

In certain embodiments, the amplifier assembly 122 can also include a cryogenically cooled gain medium 124. In certain embodiments, the cryogenically cooled gain medium 124 can be or include Iron-doped Zinc Selenide (Fe:ZnSe). Any other suitable gain medium to produce a desired result (e.g., amplification to a desired level of a certain input signal) is contemplated herein.

The cryogenically cooled gain medium 124 can be embodied as one or more gain crystals. In certain embodiments, the one or more gain crystals can be cut at Brewster's angle (e.g., 67.5 degrees). In certain embodiments, for example, the one or more gain crystals can be or include two single-crystal Fe:ZnSe crystals.

In certain embodiments, at least one surface (e.g., non-incident sides/faces) of the cryogenically cooled gain medium 124 can be coated with graphite. In certain embodiments, the cryogenically cooled gain medium 124 can be disposed in a vacuum chamber 126. In certain embodiments, only the cryogenically cooled gain medium 124 is disposed in the vacuum chamber 126.

In certain embodiments, the amplifier assembly 122 can be disposed in the vacuum chamber 126. In certain embodiments, only the amplifier assembly 122 is disposed in the vacuum chamber 126, e.g., as shown.

In certain embodiments, the one or more gain pumps 128 can be or include Erbium-doped Yttrium Aluminum Garnet (Er:YAG) configured to output a pump laser signal. Any other suitable pump type to produce a desired result (e.g., output configured to drive the gain medium as desired) is contemplated herein. In certain embodiments, the one or more gain pumps 128 can be or include two gain pumps disposed on opposite sides of the gain crystal, e.g., as shown. In certain embodiments, the pump laser signal can be about 34 millijoules, about 100 microseconds, about 333 hertz, and/or about 2.94 micrometers. Any other suitable characteristics for the pump laser signal that produce a desired result are contemplated herein. In certain embodiments, the amplifier assembly 122 can be configured to vertically polarize the one or more pump beams. In certain embodiments, the output MIR signal 132 can be below 4.2 micrometers. In certain embodiments, the output optical signal 132 can be below about 4.07 micrometers.

The output optical signal 132 can be about 333 hertz, about 250 femtoseconds, about 4.59 millijoules. Any other suitable output signal characteristics for a desired application are contemplated herein. However, it is noted that such example characteristics achieved with certain embodiments of this disclosure are previously unachievable, e.g., in room temperature air. The example output characteristics as disclosed herein are an unexpected result of certain embodiments of this disclosure.

In accordance with at least one aspect of this disclosure, a method for amplifying the power of a laser using chirped pulse amplification can include generating an output signal 132 below about 4.2 micrometers and at or above about 300 hertz. In certain embodiments, the generation can be performed in about room temperature open air. In certain embodiments, the method can include using a cryogenically cooled chirped pulse amplifier. The cryogenically cooled chirped pulse amplifier can comprise a cryogenically cooled gain medium 124. In certain embodiments, the method can include cooling the cryogenically cooled chirped pulse amplifier and/or the cryogenically cooled gain medium 124. The method can include cooling the cryogenically cooled gain medium to about 40 Kelvin. In certain embodiments, the method can also include exposing to vacuum (e.g., or suitable lower pressure) only the cryogenically cooled chirped pulse amplifier and/or the cryogenically cooled gain medium (e.g., cryogenically cooling the chirped pulse amplifier and/or gain medium in a vacuum chamber). In certain embodiments, the method can further include using one or more periodically poled lithium niobate crystals 114 to generate infrared signals from an initial optical seed signal 105.

FIG. 1 is a schematic representation of an embodiment of a chirped pulse amplifier (CPA) (e.g., a 4.07 μm CPA with energy, repetition rate, and pulse duration as denoted in FIG. 1). As shown, embodiments can include a seed generation system 102. The seed generation system 102 can include an optical source 104 (e.g., a Ytterbium-doped Potassium-Gadolinium Tungstate (Yb:KGW) laser as shown in FIG. 1) configured to output an initial optical seed signal 105. The initial optical seed signal 105 can be 247 fs, 100 μJ, and 1.025 μm, e.g., as shown in the embodiment of FIG. 1. The seed generation system 102 can include a beta barium borate (BBO) crystal 106 used to convert one-third of the pulse energy to the second harmonic (513 nm), e.g., as shown in the embodiment of FIG. 1. The seed generation system can include an ytrrium aluminum garnet (YAG) crystal 108 used to generate a near infrared (NIR) light via supercontinuum generation, e.g., as shown in the embodiment of FIG. 1. The seed generation system 102 can include a second BBO crystal 110 used to amplify the NIR light, e.g., as shown in the embodiment of FIG. 1. The seed generation system 102 can include two PPLN crystals 114 placed back-to-back to produce the seed for the CPA, e.g., as shown in the embodiment of FIG. 1. The seed generation system 102 can include a beam combiner 112 before the PPLN 114, e.g., as shown in the embodiment of FIG. 1. The seed generation system 102 can include a diffraction grating 116 for outputting the optical seed signal 117, e.g., as shown in the embodiment of FIG. 1. The optical seed signal 117 can be 2.7 μJ, 150 fs, and 4.07 μm, e.g., as shown in the embodiment of FIG. 1. Embodiments can include a stretcher 118, e.g., as shown in the embodiment of FIG. 1. The stretcher 118 can be an Öffner Stretcher. This stretcher can include a concave and convex mirror for stretching the pulse length. Embodiments can include a faraday isolator 120 located between the stretcher 118 and the amplifier assembly 122. Certain embodiments include an amplifier assembly 122, e.g., as shown in the embodiment of FIG. 1. The amplifier assembly 122 can be a bowtie eight-pass amplifier, e.g., as shown in the embodiment of FIG. 1. The amplifier assembly 122 can include a cryogenically cooled gain medium 124 which comprises of two single-crystal Fe:ZnSe crystals cut at Brewster's angle, e.g., as shown in the embodiment of FIG. 1. The Fe:ZnSe crystals can be disposed in a vacuum chamber 126 for cryogenically cooling the crystals, e.g., as shown in the embodiment of FIG. 1. The amplifier assembly 122 can include two Er:YAG gain pumps 128 which can each be split using a germanium window at a Brewster's angle, e.g., as shown in the embodiment of FIG. 1. The Er:YAG gain pumps 128 can each output a gain pump signal (e.g., that is 34 mJ, 100 μs, 333 Hz, and 2.94 μm), e.g., as shown in the embodiment of FIG. 1. The amplifier assembly 122 can include sixteen mirrors 127 which are configured to permit eight-passes of the signal through the cryogenically cooled gain medium 124, e.g., as shown in the embodiment of FIG. 1. The amplifier assembly 122 can output an amplified optical signal (e.g., that is 6.08 mJ, 180 ps, and 333 Hz), e.g., as shown in the embodiment of FIG. 1. Certain embodiments can include a compressor assembly 130, e.g., as shown in the embodiment of FIG. 1. The compressor assembly 130 can output an output optical signal 132 (e.g., that is 4.59 mJ, 250 fs, 333 Hz, and 4.07 μm), e.g., as shown in the embodiment of FIG. 1.

FIG. 2 shows a graphical representation of pulse contrast measurement showing the amplifier output 208 and amplified spontaneous emission 210 (ASE) for one or more embodiments of this disclosure (e.g., as shown in FIG. 1). The graph 200 displays normalized output voltage 202 and normalized ASE voltage 204 against time 206. The ASE pulse is not visible above the electronic background noise of the red trace, indicating a pulse contrast of greater than 100. FIG. 2 shows the traces of the ASE and of the amplified pulse itself captured using a HgCdTe detector (e.g., of Thorlabs) on different scales. The trace of the amplifier output 208 shows the amplified pulse as a sharp spike 212 at about 70 μs while ASE is not visible above the background of this trace. This indicates pulse contrast can be achieved well over 100. Moreover, the crystal walls were coated with absorptive graphite ink, as has been shown to reduce internal reflections.

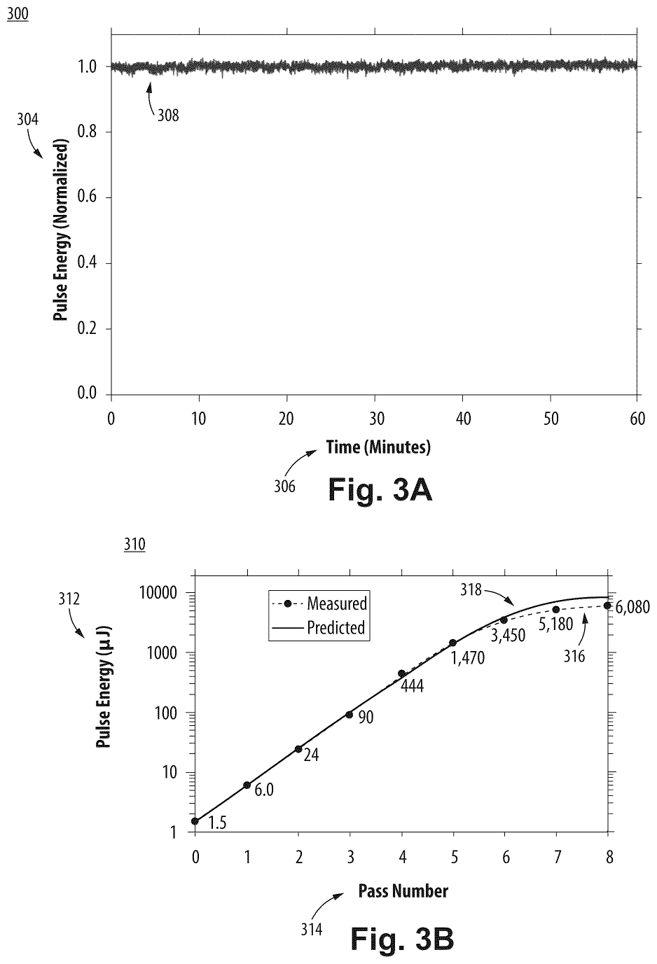

FIG. 3A shows a graphical representation of measured long-term power fluctuation for one or more embodiments of this disclosure (e.g., as shown in FIG. 1). The graph 300 displays normalized pulse energy 304 against time 306. Long-term power stability 308 is good with a root mean square error of 0.95% of the average. By sampling at a rate of 45 ms over 5 minutes, the standard deviation of the pulse energy was found to be 2.84% of the average.

FIG. 3B shows a graphical representation of measured pulse energy versus pass number and predicated pulse energy for one or more embodiments of this disclosure (e.g., as shown in FIG. 1) based on the Franz-Nodvik equation. The graph 310 displays pulse energy 312 against pass number 314. After eight passes, the measured pulse energy 316 is 6.08 mJ, which agrees with the predicted pulse energy 318. A small-signal single-pass gain of 4.0 and a total gain of about 4,000 are achieved with an average single-pass gain per pass greater than 3. The seven-pass CPA achieved a total gain of just 1,125. The single-pass gain at the final pass is 1.17, indicating that the gain medium is not yet fully saturated. The peak fluence of the laser beam in the final pass is 77 mJ/cm², which is below the estimated laser-induced damaged threshold at the duration of the stretched pulse.

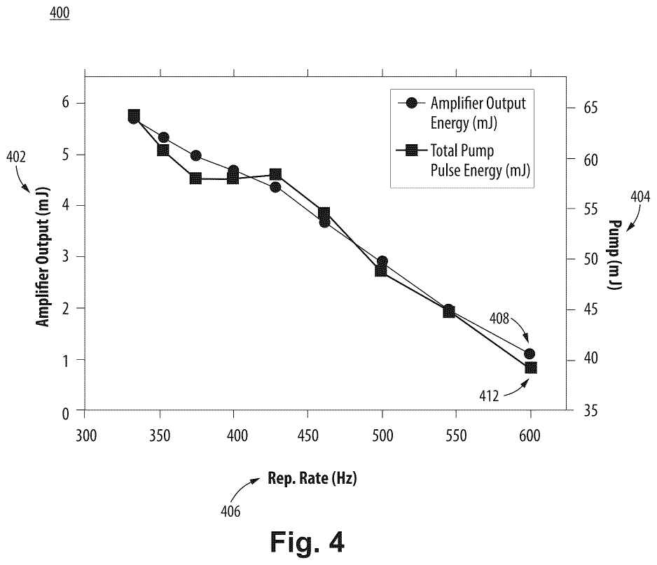

FIG. 4 shows a graphical representation of an eight-pass amplifier output and pump pulse energy at different repetition rates for one or more embodiments of this disclosure (e.g., as shown in FIG. 1). The graph 400 displays amplifier output 402 and pump energy 404 against repetition rate 406. FIG. 4 shows that both the pump pulse energy 412 and the multi-pass amplifier (MPA) output 410 decrease with increasing repetition rate. Therefore, more passes can be used to increase the repetition rate while maintaining the same output energy.

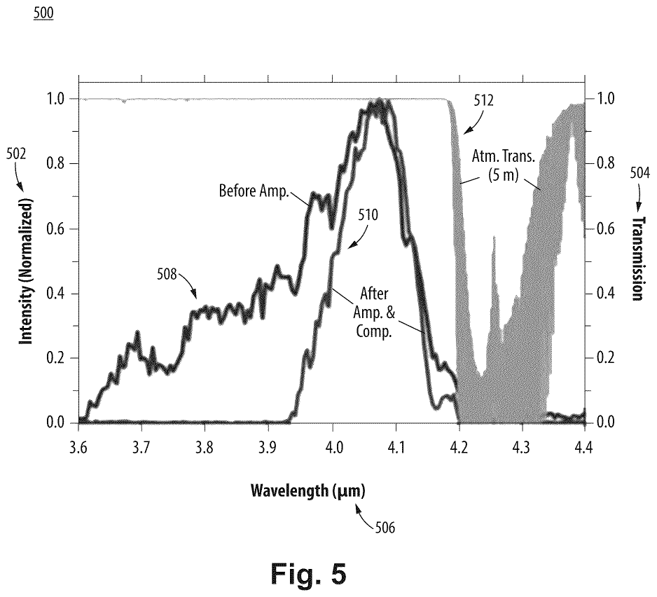

FIG. 5 is a graphical representation of the spectra before and after amplification (e.g., with five (5) meters of atmospheric CO₂ absorption denoted for reference) for one or more embodiments of this disclosure (e.g., as shown in FIG. 1). The graph 500 displays normalized intensity 502 and transmission 504 against wavelength 506, measuring before amplification 508, after amplification and compression 510, and 5 meters of atmospheric CO₂ absorption 512. After amplification and compression 510, the spectrum is centered at 4.07 μm. After compression using a Treacy grating pair (e.g., Richardson Gratings), 4.59 mJ pulses at 4.07 μm and 333 Hz were measured. The average power is 1.53 W, which is 44 times higher than the Fe:ZnSe-based CPA operating at near room temperature. Compressor throughput was measured to be 79%. The spectral bandwidth of the pulse supports a Fourier-transform-limited duration of 237 fs. A full width at half maximum (FWHM) pulse duration of 250 fs was measured using a second harmonic autocorrelator. Spectral measurements were taken using a spectrometer (e.g., sold by APE).

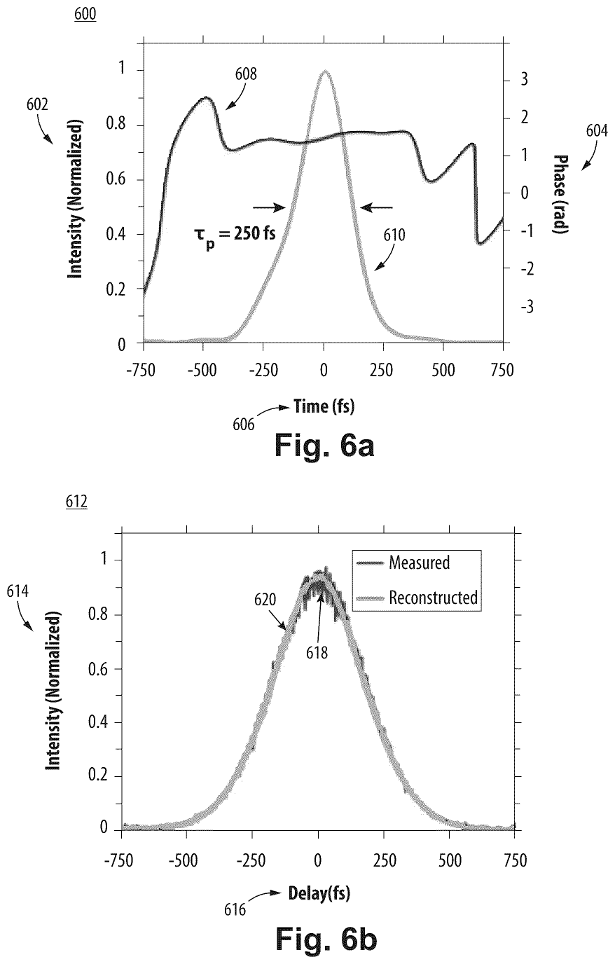

FIG. 6A shows a graphical representation of pulse shape 610 and spectral phase 608 retrieved by applying the phase-enabled nonlinear gating with unbalanced intensity (PENGUIN) algorithm to an unbalanced interferometric autocorrelation trace for one or more embodiments of this disclosure (e.g., as shown in FIG. 1). The graph 600 displays normalized intensity 602 and phase 604 against time 606.

FIG. 6B shows a graphical representation of a comparison of the intensity autocorrelation traces between the one reconstructed based on the pulse shape in FIG. 6B and the one measured using an autocorrelator (e.g., sold by APE) for one or more embodiments of this disclosure (e.g., as shown in FIG. 1). The graph 612 displays normalized intensity 614 against delay 616. The reconstructed intensity autocorrelation trace 620 was compared to the measured intensity autocorrelation trace 618 to validate the results.

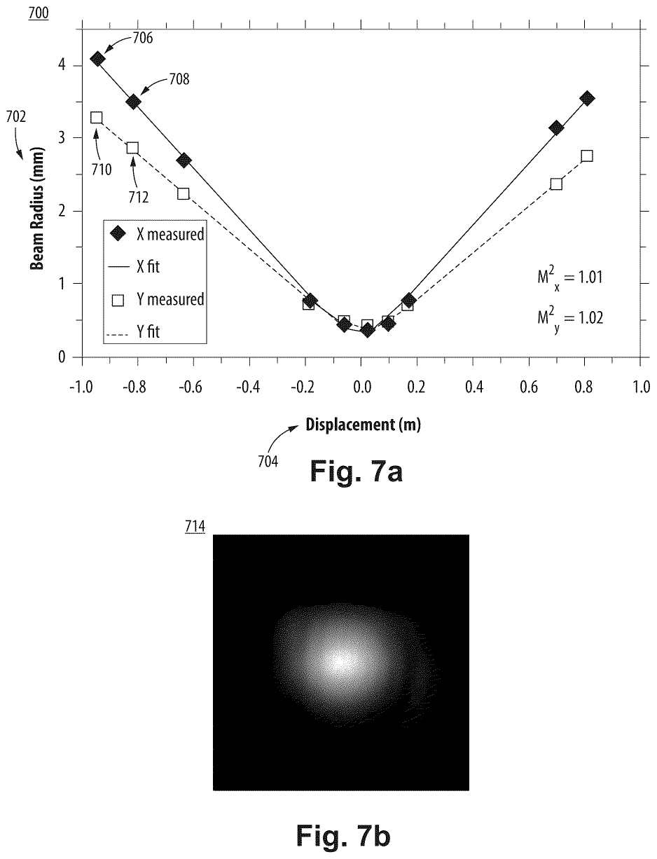

FIG. 7A shows a graphical representation of beam profile and beam quality after compression for one or more embodiments of this disclosure (e.g., as shown in FIG. 1). The graph 700 displays beam radius 702 against displacement 704. The graph 700 shows points of measured x position 706 and of measured y position 710, and of the x fit line 708 and y fit line 712. The output beam is Gaussian-like, with a 1/e² diameter of 10 mm. M² along the x and y axes was measured to be 1.01 and 1.02 respectively. Because of the cryogenic cooling in the crystals, beam quality is excellent with an M² value near 1 at the 333 Hz repetition rate. Measurements were made using a pyroelectric camera (e.g., sold by Ophir-Spiricon). FIG. 7B shows an image 714 of the beam profile captured using a pyroelectric array camera.

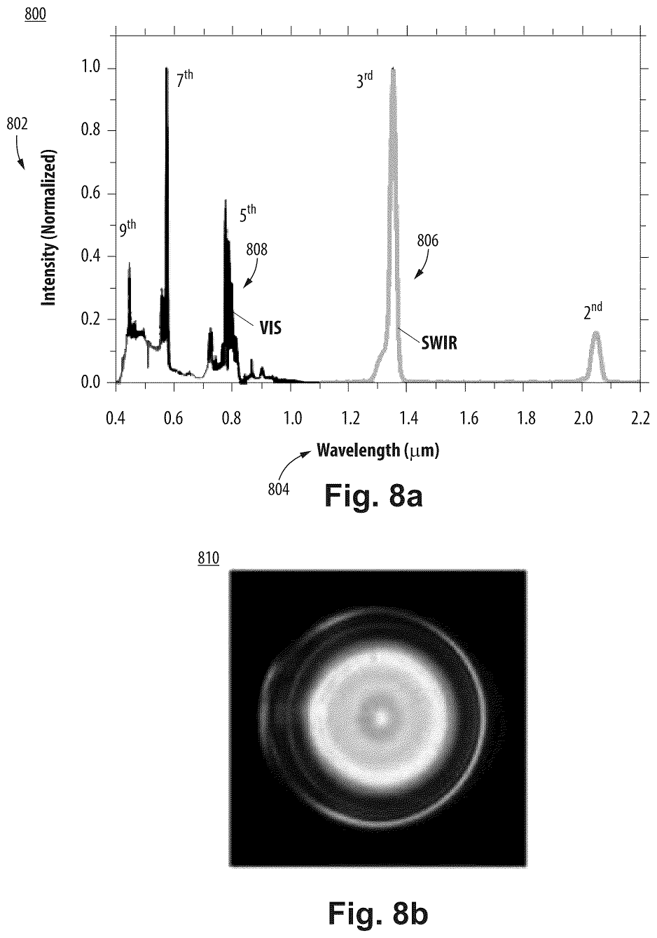

FIG. 8A is a graphical representation of the spectra of the third (1357 nm), fifth (814 nm), seventh (581 nm), and ninth harmonics generated by tightly focusing the output beam in air for one or more embodiments of this disclosure (e.g., as shown in FIG. 1). A second harmonic signal is also observed at 2.04 μm. The graph 800 displays normalized intensity 802 against wavelength 804. The harmonics spectrum spanned the sensitivity regions of a Si-based (VIS) 808 and an InGaAs-based (SWIR) 806 spectrometers. The source was able to generate odd harmonics up to the ninth order (~452 nm) when focused in air by a lens with a 40-mm focal length, indicating its potential for use in strong-field experimentation. Also observed in FIG. 8 is a ~2-μm signal suggesting SHG that occurs somewhere in the system.

FIG. 8B shows a color photo 810 of the conical emission from the filament.

Certain embodiments of an optical system for a Fe:ZnSe CPA system can be as shown in FIG. 1. In certain embodiments, the system can be a cryogenically cooled, Fe:ZnSe-based chirped pulse amplifier, pumped by free-running Er:YAG lasers 128. The system can be configured to begin with a MIR seed generation system 102, which can include a two-stage optical parametric amplifier (OPA). The OPA can be configured to be pumped by a turn-key Yb-based laser, or in certain embodiments, a Cr:Forsterite laser at 1.24 μm. The initial seed pump pulses 105 can be configured to originate from a Yb:KGW laser, which can be configured to output a 1.025-μm, 100-μJ, 247-fs laser capable of running up to 12-kHz (e.g., Light Conversion, Carbide). The seed generation system 102 can be configured so that one third of the pulse energy is converted to the second harmonic (513 nm) via a 1.5-mm thick beta barium borate (BBO) crystal 106. In certain embodiments, the seed generation system 102 can include a 10-mm long bulk yttrium aluminum garnet (YAG) crystal 108 which can be configured to generate a NIR (~1.37 μm) seed via supercontinuum generation.

In certain embodiments, in the first stage of amplification, the NIR light can be amplified to 1.38 μJ by 31 μJ of the second harmonic pulse via type-I, non-collinear OPA in a 2-mm thick BBO crystal 110. In certain embodiments, a non-collinear angle (e.g., the angle between the idler and pump) of, or about, 4.2° can be used to minimize parasitic second harmonic generation (SHG) of the idler. In certain embodiments, in the second stage, collinear difference frequency generation in two 1-mm thick, fanout, periodically poled lithium niobate (PPLN) 114 chips (e.g., sold by HC Photonics Corp.), which can be configured to be placed back-to-back between the NIR pulse and 62 μJ of the fundamental (1.025 μm), can be configured to produce the seed for the CPA with 2.7-μJ, 150-fs pulses at 4.07 μm and up to 12 kHz. In certain embodiments, the duration can be measured using a SHG autocorrelator (e.g., sold by APE). In certain embodiments, after amplification, a 600-line/mm holographic grating (e.g., sold by Spectrogon) can be used to attenuate the pump by diffracting part of it while effectively acting as a mirror to the MIR idler pulse. In certain embodiments, the reflectivity of the grating in this configuration for the MIR pulse can be about 99%. In certain embodiments, this method of long-pass filtering was shown to help prevent damage to later optics caused by the intense pump beam and was found to be more practical than using absorptive materials such as, but not limited to, germanium or silicon due to nonlinear effects present in those materials under high intensities.

In certain embodiments, pulses can be stretched to over 400 ps in a stretcher 118. In certain embodiments, the stretcher 118 can be a Öffner-style stretcher that is nearly aberration free. The stretcher 118 can be configured to comprise of a concave mirror and a convex mirror with radii of curvature of, or about, 1000-mm and 505-mm respectively and a grating of groove density of, or about, 240 lines/mm (Richardson Gratings). In certain embodiments, a 35.5° incident angle can be used to increase stretcher throughput efficiency, which was measured to be 75%. In certain embodiments, due to gain-narrowing, by the final pass in the multi-pass amplifier, the pulse

### Duration Has Been Shown to Be About 180 Ps.

In certain embodiments, two single-crystal Fe:ZnSe crystals (e.g., sold by 3photon Ltd.) can be cut at Brewster's angle (e.g., 67.5°), have dimensions of 8×8×10 mm³, and/or have ion concentration 5×10¹⁸ cm⁻³. In certain embodiments, the crystal(s) can be configured to be cooled to 40 K using, but not limited to, a close-loop cold-helium circulation system (e.g., sold by Cryomech). In certain embodiments, vibrations from the helium compressor and cold head can be largely eliminated via use of a 23-ft long, flexible tube transporting compressed helium to a cold finger on which the crystals can be mounted. The crystals can also be configured to be situated in a chamber 126 evacuated to 10⁻⁷ mbar (e.g., a vacuum chamber 126). In certain embodiments, the vacuum chamber 126 can include two CaF₂ windows at Brewster's angle configured to be optical inputs. The windows can be pumped from both sides at, or about, 2.94 μm using, but not limited to, one or more 34-mJ, 333-Hz, 100-μs, diode-pumped Er:YAG lasers 128 (e.g., made by Pantec, DPM-50). In certain embodiments, the repetition rate can be configured to be more than an order of magnitude higher than a Q-switched, nanosecond laser. In certain embodiments, the 2.94-μm pulses of the one or more pump lasers can be configured to be split using a germanium window at Brewster's angle, which can act as a partially polarizing beamsplitter. In certain embodiments, the polarization vectors of the transmitted beams can be rotated 90° by a half-waveplate to make them vertical. In certain embodiments, these transmitted beams can be configured to provide a pair of vertically polarized beams on both sides of the chamber to pump the Fe:ZnSe crystals. In certain embodiments, these four pump beams can be roughly flat-top and can have a beam diameter of 3.2 mm. In certain embodiments, the seed beam diameter can be 3.1 mm at the 1/e² level at the last pass. These beams can be configured to be incident on the crystals at Brewster's angle meaning that their actual profiles during amplification are elliptical. In certain embodiments, using these pump settings, the crystal mount has shown temperature increases slowly until reaching 62 K. In certain embodiments, this system has shown that nearly 100% of the pump pulses can be absorbed by the crystals. In certain embodiments, according to simulations, the temperature of the active region of the crystals during operation has been observed to be 64 K. In certain embodiments, all components of the optical layout 100 of the CPA system, except the one or more crystals, are placed in ambient air, which can enable easier alignment than placing them in a vacuum.

In certain embodiments, the seed laser pulses can be configured to be amplified in an eight-pass bowtie amplifier 122. In certain embodiments, the amplified spontaneous emission (ASE) arising from small amounts of fluorescence reflected by various optics in the system was observed to become more significant as the number of passes through the amplifier was increased. In certain embodiments, a primary source of the reflection and scattering was determined to be inside the stretcher 118. In certain embodiments, the system can include a faraday isolator 120 (e.g., made by Thorlabs) which can be configured to be inserted between the stretcher 118 and amplifier assembly 122 to curtail energy-depleting ASE. In certain embodiments, the Faraday isolator 120 was observed to have reduced ASE to ~0.25% of the total output average power, allowing more of the pump energy to be imparted to seed.

In certain embodiments, cooling the Fe:ZnSe to cryogenic temperature for use in a CPA has certain advantages that have been observed and validated. High-repetition-rate, free-running Er:YAG lasers (e.g., originally built for medical applications) can be used as pump lasers thanks to the increased upper-state lifetime. In certain embodiments, cooling Fe:ZnSe to cryogenic temperature can result in 333-Hz repetition rate and 1.53-W average output power of the CPA laser, which are respectively about 33 and 44 times higher (unexpectedly) than what were previously demonstrated at near-room temperature. In certain embodiments, the beam quality and power stability of the output beam were observed to be excellent. In certain embodiments, it was shown that increasing the repetition rate by adding more passes through the amplifier 122 can be feasible. In certain embodiments, the 4.07-μm center wavelength allows all laser components except the gain crystals to be placed in ambient air, instead of in a vacuum chamber 126 because the wavelength is below the CO₂ absorption level of 4.2-4.4 μm. In certain embodiments, seeding the CPA by an Yb-laser-pumped OPA is also demonstrated. In certain embodiments, further compression of output pulses by high-order spectral phase correction and spectral broadening in nonlinear media can be configured to be implemented to apply this source to isolated attosecond pulse generation and to the study of MIR filamentation in the air.

Since the advent of chirped pulse amplification (CPA) in the 1980s, and the advancement of the Ti:Sapphire laser in the 1990s, the near-infrared (NIR) CPA laser centered at 800 nm has been used for attosecond scientific research based on high harmonic generation (HHG). The cut-off energy of a phase-matched high harmonic spectrum obtained from a traditional Ti:Sapphire source, however, is limited to about 150 eV. The next major step forward for attosecond sources can extend the HHG cut-off energy by taking advantage of wavelength scaling laws via new gain media and nonlinear techniques. With recent advances in ultrafast driving sources in the short-wave infrared (SWIR, e.g., 1.4-3 μm) region, attosecond pulses extending into the water window (282-533 eV), in which water is less absorptive than carbon, and beyond, have now been demonstrated. However, photon flux has never been high enough for time-resolved study of the oxygen K-edge (533 eV). Efficiently probing electron dynamics beyond the water window and into the keV region traditionally would require sources that are or were not extant. Pushing past the SWIR region, and into the mid-infrared (MIR, e.g., 3-8 μm) region, is made more difficult by the lack of technologically mature optical materials, opto-electronics, and detection methods, and by atmospheric absorption at certain wavelengths.

Examples of ultrafast MIR sources include optical parametric chirped pulse amplifiers (OPCPA) pumped at 1 μm and 2 μm and chirped pulse amplifiers (CPA) seeded by optical parametric amplifiers (OPA). OPCPAs based on nonlinear crystals that can be pumped by Yb/Nd-laser-based, 1-μm sources, such as potassium titanyl arsenate (KTA) and lithium niobate (LNB) have been shown to reach a peak power of 300 GW in the MIR region. However, repetition rates tend to be low, in the 10-20 Hz range. Chirped pulse amplification in near-room-temperature (e.g., 7° C.) using Fe:ZnSe has been observed to yield 150-fs, 3.5-mJ pulses centered at 4.4 μm, but repetition rate was low at 10 Hz. The full seven-pass CPA laser system was placed in a vacuum chamber to avoid energy loss and spectral distortion caused by strong CO₂ absorption in the 4.2-4.4-tim region. Due to the short upper-state lifetime of Fe:ZnSe at 7° C. (~1 μs), a home-built 40-ns, 10-Hz, Q-switched Cr:Yb:Ho:YSGG laser was used as the pump. The average power of this CPA output is 35 mW, which is too low for driving HHG for time-resolved attosecond experiments.

Cryogenically cooling Fe:ZnSe, as shown through this disclosure, can offer several advantages over running at room temperature such as, but not limited to, allowing repetition rate to be over an order of magnitude higher. In certain embodiments, the upper-state lifetime of Fe:ZnSe has been observed to peak at around 80 K, increasing from hundreds of nanoseconds to about 55 μs. In certain embodiments, commercially available, free-running microsecond lasers, instead of home-made Q-switched nanosecond lasers, can be used as pumps. In certain embodiments, the thermal conductivity of Fe:ZnSe has been observed to be roughly five times higher at 80 K than at room temperature allowing greater heat dissipation during pumping. This can reduce thermal lensing, supporting good beam quality. In certain embodiments, the emission cross section peak of Fe:ZnSe has been observed to shift down in wavelength from about 4.3 μm to about 4.1 μm allowing the avoidance of the strong CO₂ absorption lines in atmosphere at roughly 4.2-4.4 μm. The above-noted near-room-temperature Fe:ZnSe experiment was implemented a 0.5-Torr vacuum chamber around the entire CPA to avoid beam distortion and absorption. In a later iteration of this source, pulses were produced without a vacuum chamber at 4.5 μm to avoid CO₂ absorption; however, pulse energy was reduced to about 3 mJ and more passes were required. In certain embodiments, the optical system 100 comprises a 4.07-μm, cryogenically cooled Fe:ZnSe CPA outputting an output optical signal 132 of 250-fs, 4.59-mJ pulses at 333 Hz.

In certain embodiments, a femtosecond chirped pulse amplifier based on cryogenically cooled Fe:ZnSe was demonstrated at 333 Hz-33 times higher than previous results achieved at near-room-temperature. In certain embodiments, the long upper-state lifetime can allow for free-running, diode-pumped Er:YAG lasers 128 to be used as pump lasers. In certain embodiments, 250-fs, 4.59-mJ pulses 132 are produced with a center wavelength of 4.07 μm, which avoids strong atmospheric CO₂ absorption that cuts on around 4.2 μm. In certain embodiments, the optical system can be configured to operate the laser in ambient air with good beam quality. In certain embodiments, by focusing the 18-GW beam in air, harmonics up to the ninth order were observed indicating its potential for use in strong-field experimentation. In certain embodiments, this system can include a highly stable, commercially available, Yb:KGW laser as the pump source for its seed generation system 102, which greatly reduces complexity of the seed generation system 102. In certain embodiments, the optical system 100 and/or CPA system can be used for, but not limited to, high-harmonic generation (e.g., for driving high harmonics in a gas target for fundamental science research), filamentation research, free-space communication, directed energy applications, LIDAR, MIR spectroscopy, materials processing, and/or remote sensing.

Traditional systems required complex pumping schemes involving Q-switched lasers and purged or vacuum conditions due to CO₂ absorption. Traditional systems resulted in a much lower beam quality with an M² of about 1.8 and used a much more complex seed generation system.

Those having ordinary skill in the art understand that any numerical values disclosed herein can be exact values or can be values within a range. Further, any terms of approximation (e.g., “about”, “approximately”, “around”) used in this disclosure can mean the exact stated value and the stated value within a range. For example, in certain embodiments, for the stated values disclosed herein, the range is within (plus or minus) 20% of the stated value. In certain embodiments of the stated values disclosed herein, the range is within (plus or minus) 10% of the stated value. In certain embodiments, for the stated values disclosed herein, the range is within (plus or minus) 5% of the stated value. In certain embodiments, for the stated values disclosed herein, the range is within (plus or minus) 2% of the stated value. In certain embodiments, for the stated values disclosed herein, the range is within (plus or minus) 1% of the stated value. In certain embodiments, for the stated values disclosed herein, the range is within (plus or minus) 0.5% of the stated value. In certain embodiments, for the stated values disclosed herein, the range is within (plus or minus) 0.25% of the stated value. In certain embodiments, for the stated values disclosed herein, the range is within (plus or minus) 0.1% of the stated value. In certain embodiments, for the stated values disclosed herein, the range is within (plus or minus) 0.05% of the stated value. In certain embodiments, for the stated values disclosed herein, the range is within (plus or minus) 0.01% of the stated value. In certain embodiments, for the stated values disclosed herein, the range is within (plus or minus) 0.001% of the stated value. In certain embodiments, for the stated values disclosed herein, the range is within any other suitable percentage or number as appreciated by those having ordinary skill in the art (e.g., for known tolerance limits or error ranges). In certain embodiments, any combination of the above ranges for any combination of stated values are contemplated herein.

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of this disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. An optical system, comprising:
a seed generator system configured to output an optical seed signal;
a stretcher in optical communication with the seed generator system to receive the optical seed signal, the stretcher is configured to stretch the optical seed signal to output a stretched seed signal;
an amplifier assembly in optical communication with the stretcher to receive the stretched seed signal, the amplifier comprising:
a cryogenically cooled gain medium configured to receive the stretched seed signal and amplify the stretched seed signal to output an amplified optical signal; and
one or more gain pumps configured to output one or more pump signals to pump the cryogenically cooled gain medium; and
a compressor in optical communication with the amplifier assembly configured to receive the amplified optical signal and to compress the amplified optical signal to output an output optical signal.

2. The optical system of claim 1, wherein the seed generator system comprises a Yb:KGW optical source configured to output an initial optical seed signal.

3. The optical system of claim 2, wherein the initial optical seed signal is about 247 femtoseconds, about 100 microjoules, and/or about 1.025 micrometers.

4. The optical system of claim 1, wherein the seed generator system includes one or more infrared generator elements configured to generate one or more infrared signals from infrared generator optical input signal.

5. The optical system of claim 4, wherein one or more of the infrared generator elements are or include one or more periodically poled lithium niobate (PPLN) crystals configured to generate one or more infrared signals from an infrared generator optical input signal, wherein the one or more PPLN crystals are disposed optically between a combiner grating and an output grating to receive the infrared generator optical input signal from the combiner grating to output a PPLN output signal to the output grating, wherein the output grating is configured to separate the one or more infrared signals from the PPLN output signal to output the optical seed signal.

6. The optical system of claim 4, wherein a focal point of the combiner grating is at the output grating.

7. The optical system of claim 1, wherein the optical seed signal is below 4.2 micrometers and/or about 4.07 micrometers.

8. The optical system of claim 7, wherein the optical seed signal is about 150 femtoseconds and/or about 2.7 microjoules.

9. The optical system of claim 1, wherein the stretcher is an Öffner stretcher.

10. The optical system of claim 1, wherein the amplifier assembly includes an eight-pass bowtie amplifier arrangement, and/or further comprising a faraday isolator disposed between the stretcher the amplifier assembly, wherein the faraday isolator is configured to prevent signals from returning backward to and/or through the stretcher.

11. The optical system of claim 1, wherein the cryogenically cooled gain medium is Fe:ZnSe.

12. The optical system of claim 11, wherein the cryogenically cooled gain medium is one or more gain crystals.

13. The optical system of claim 11, wherein the one or more gain crystals include two single-crystal Fe:ZnSe crystals cut a Brewster's angle.

14. The optical system of claim 11, wherein at least one surface of the cryogenically cooled gain medium is coated with graphite.

15. The optical system of claim 11, wherein the cryogenically cooled gain medium is disposed in a vacuum chamber.

16. The optical system of claim 15, wherein only the cryogenically cooled gain medium is disposed in the vacuum chamber.

17. The optical system of claim 1, wherein the one or more gain pumps are Er:YAG configured to output a pump laser signal.

18. The optical system of claim 1, wherein the one or more gain pumps include two gain pumps disposed on opposite sides of the gain crystal.

19. The optical system of claim 1, wherein the output optical signal is below 4.2 micrometers and/or about 4.07 micrometers.

20. A method for MIR chirped pulse amplification, comprising generating an output signal below about 4.2 micrometers and at or above about 300 hertz in about room temperature open air using a cryogenically cooled chirped pulse amplifier.
